(19) United States
(12) Patent Application Publication
(10) Pub. No.: US 2015/0248156 A1
(43) Pub. Date: Sep. 3, 2015

(54) INFORMATION PROCESSING APPARATUS

(71) Applicant: CANON KABUSHIKI KAISHA, Tokyo (JP)

(72) Inventor: Takahiro Haraguchi, Kawasaki-shi (JP)

(21) Appl. No.: 14/634,331

(22) Filed: Feb. 27, 2015

(30) Foreign Application Priority Data
Mar. 3, 2014 (JP) 2014-040490

(51) Int. Cl. G06F 1/32

(52) U.S. Cl. CPC G06F 1/3296

(57) ABSTRACT

An information processing apparatus includes an operation unit that receives an input from a user operating the information processing apparatus, an arm member that connects a main body of the information processing apparatus and the operation unit, and a detection unit, attached to the arm member or the operation unit attached to the arm member, that detects the user operating the information processing apparatus.

### BACKGROUND

1. Field

Aspects of the present invention generally relate to an information processing apparatus which uses a human detection sensor and detects a person approaching the apparatus.

2. Description of the Related Art

There is a technique for causing an image forming apparatus to return from a power saving state by detecting that a person has approached the image forming apparatus (refer to Japanese Patent Application Laid-Open No. 2012-168211).

More specifically, Japanese Patent Application Laid-Open No. 2012-168211 discusses two sensors attached near an operation unit disposed on a front side of the apparatus. If a first sensor detects a person, a second sensor starts performing detection. If the second sensor then detects the person, the image forming apparatus returns from the power saving mode.

Further, there is an apparatus in which the operation unit is arranged via a rotatable arm member so that the operation unit can be arranged in a position desired by a user. The user of the apparatus in which the operation unit is arranged via the arm member thus moves towards the operation unit. However, if the human detection sensor is fixedly attached to the apparatus as discussed in Japanese Patent Application Laid-Open No. 2012-168211, the user moving towards the operation unit arranged via the arm member cannot be detected. As a result, the apparatus cannot be caused to automatically return from the power saving state.

### SUMMARY

Aspects of the present invention are generally directed to an information processing apparatus that includes an operation unit arranged via an arm member and returns from a power saving state by detecting using a detection unit a user approaching the operation unit arranged via the arm member.

According to an aspect of the present invention, an information processing apparatus includes an operation unit configured to receive an input from a user operating the information processing apparatus, an arm member configured to connect a main body of the information processing apparatus and the operation unit, and a detection unit, attached to the arm member or the operation unit attached to the arm member, configured to detect the user operating the information processing apparatus.

Further features of the present disclosure will become apparent from the following description of exemplary embodiments with reference to the attached drawings.

### BRIEF DESCRIPTION OF THE DRAWINGS

FIGS. 1A and 1B illustrate examples of external views of an image processing apparatus in which an operation unit is arranged via an arm.

FIGS. 2A and 2B illustrate examples of external views of the operation unit.

FIGS. 3A, 3B, and 3C are enlarged views illustrating the arm and a panel base.

FIG. 4 illustrates an example of a configuration of the image processing apparatus including a controller unit.

FIG. 5 illustrates an example of a configuration of a power supply circuit of the image processing apparatus.

FIG. 6 is illustrates a power state of the image processing apparatus.

FIG. 7 is a flowchart illustrating an example of a process performed by the image processing apparatus.

FIGS. 8A and 8B illustrate a method for determining an attachment angle of a human detection sensor.

FIGS. 9A and 9B illustrate examples of a relation between a height of the operation unit and a detection distance.

FIG. 10 illustrates the human detection sensor arranged on the arm.

FIGS. 11A and 11B illustrate examples of the relation between the height of the operation unit and the detection distance.

FIGS. 12A and 12B illustrate examples of arrangement of the human detection sensor.

### DESCRIPTION OF THE EMBODIMENTS

Exemplary embodiments will be described below with reference to the drawings.

The present disclosure relates to a technique for controlling an image processing apparatus by detecting a person approaching the apparatus using a human detection sensor. For example, the present disclosure relates to types and arrangements of sensors to be attached in the case where an operation unit is arranged on the image processing apparatus employing an arm-shaped supporting member.

The image processing apparatus according to a first exemplary embodiment in which a human detection sensor 1080 is arranged on an operation unit 1090 will be described below.

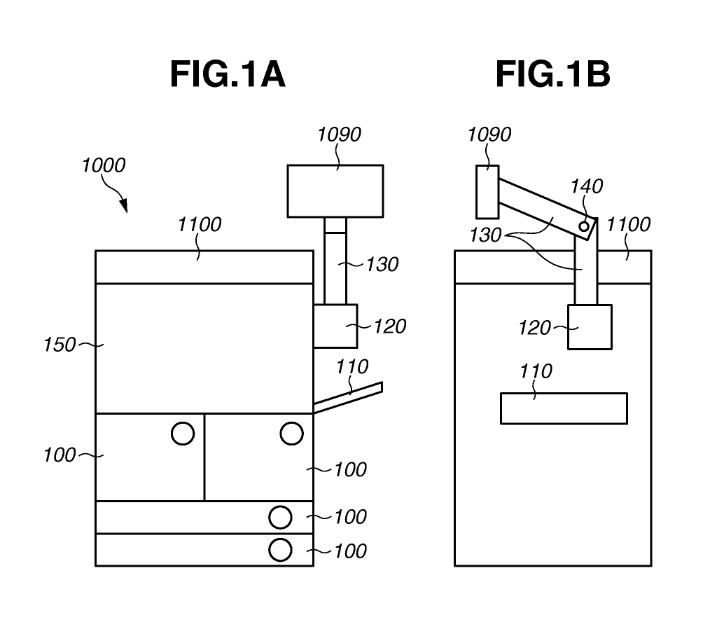

FIGS. 1A and 1B illustrate examples of external views of an image processing apparatus 1000 including an operation unit 1090 arranged via an arm 130.

More specifically, FIG. 1A illustrates the image processing apparatus 1000 viewed from the front, and FIG. 1B illustrates the image processing apparatus 1000 viewed from a right side surface.

Referring to FIGS. 1A and 1B, the image processing apparatus 1000 includes a scanner unit 1100, a front door 150, and a sheet cassette 100. Further, the image processing apparatus 1000 includes a panel base 120, an arm 130, the operation unit 1090, and a manual feed tray 110.

The front door 150 is an external cover of the image processing apparatus 1000 arranged on the front side of the image processing apparatus 1000. When the front door 150 is opened, a fixing unit and a toner bottle (not illustrated) of the image processing apparatus 1000 appear.

The sheet cassette 100 storing printing sheets is arranged on the front side of the image processing apparatus 1000. The image processing apparatus 1000 feeds the printing sheet from the sheet cassette 100 and prints an image on the printing sheet.

Further, the printing sheet is set on the manual feed tray 110 disposed on the right side of the image processing apparatus 1000. The image processing apparatus 1000 feeds the printing sheet from the manual feed tray 110 and prints an image on the printing sheet. When the printing sheet is to be fed from the manual feed tray 110, it is necessary for the user to set a sheet feed destination on the operation unit 1090.

The panel base 120 is a pedestal on which the arm 130, i.e., a support of the operation unit 1090, is disposed. The panel base 120 is arranged on the right side of the image processing apparatus 1000.

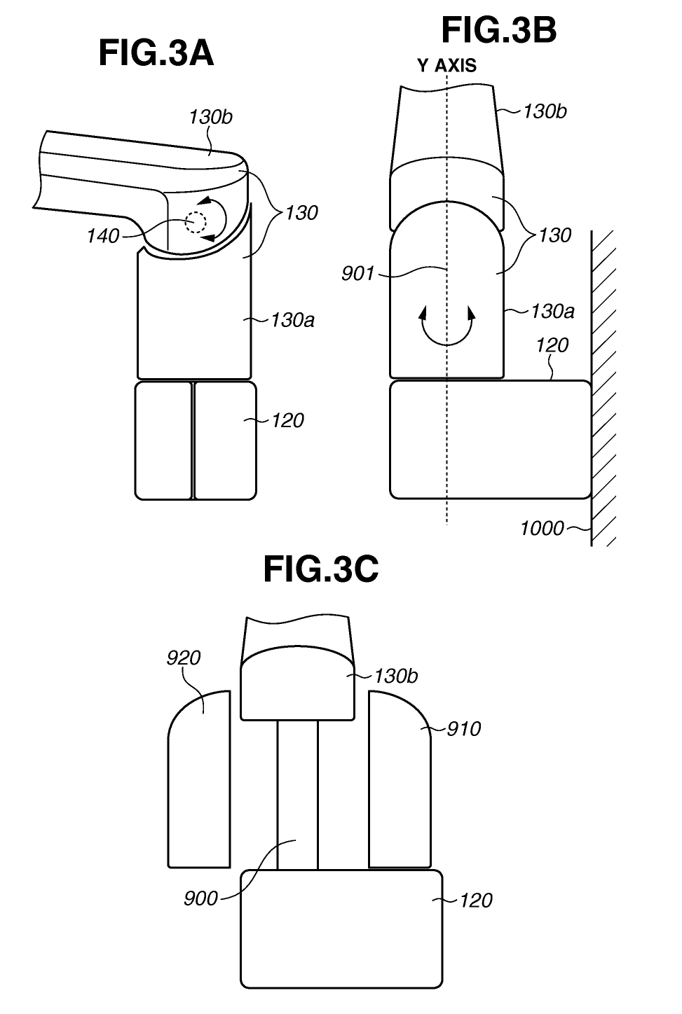

The arm 130 is the support for supporting the operation unit 1090, and the operation unit 1090 is connected to the image processing apparatus 1000 via the arm 130. The arm 130 includes a hinge 140, and the operation unit 1090 moves vertically with the hinge 140 as a fulcrum. The arm 130 moves horizontally with the panel base 120 as the fulcrum. In other words, the arm 130 supports the operation unit 1090 and allows the height and an angle of the operation unit 1090 to be adjusted. Further, the arm 130 allows the position of the operation unit 1090 to freely change with respect to a periphery of the main body of the image processing apparatus 1000. For example, the arm 130 may be rotatable so that the operation unit 1090 reaches a back side of the image processing apparatus 1000 in addition to the front side. The arm 130 will be described in detail below with reference to FIG. 3.

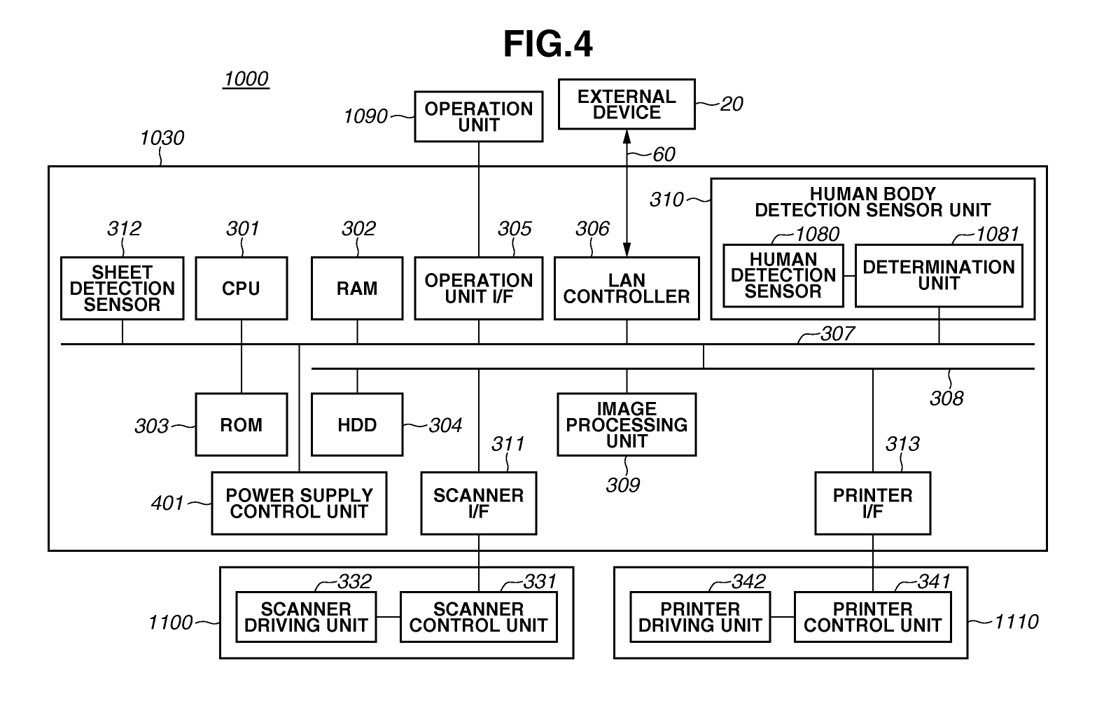

The scanner unit 1100 reads an image printed on the sheet, converts the read image to electronic data, and outputs the result to a controller 1030 (illustrated in FIG. 4). The scanner unit 1100 is arranged on an upper side of the image processing apparatus 1000 and connected to the controller 1030 via a cable (not illustrated).

The operation unit 1090 is a user interface for inputting settings and operation instructions to the image processing apparatus 1000.

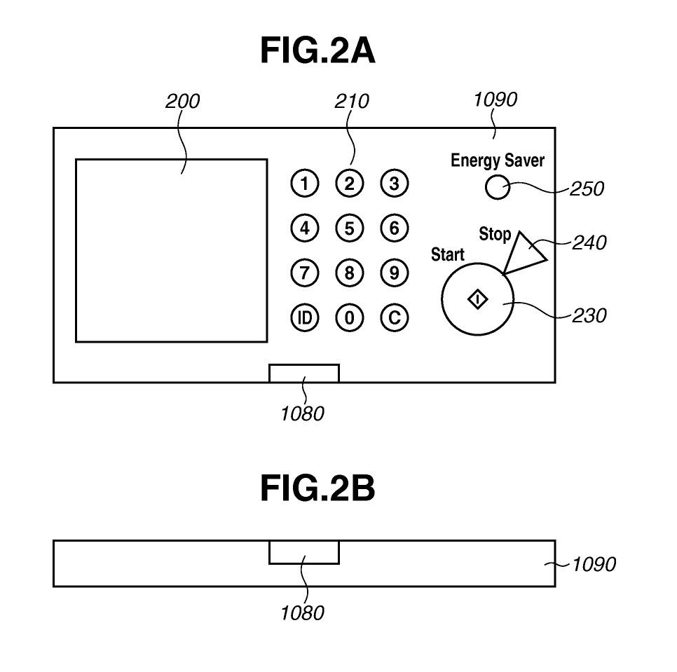

FIGS. 2A and 2B illustrate examples of external views of the operation unit 1090.

More specifically, FIG. 2A illustrates the operation unit 1090 viewed from the front, and FIG. 2B illustrates the operation unit 1090 viewed from a lower side.

The operation unit 1090 is an upright operation unit intended to be used in an upright state. Referring to FIG. 2A, the operation unit 1090 includes a display unit 200, a numeric keypad 210, a start key 230, a power saving key 250, and a human detection sensor 1080.

The display unit 200 displays a screen for operating the image processing apparatus 1000. For example, if a copy function has been selected on the image processing apparatus 1000, the image processing apparatus 1000 displays a screen specialized for the user to perform a copy operation. Further, the settings of the image processing apparatus 1000 are specified via the display unit 200.

The numeric keypad 210 is for inputting numerical values. The start key 230 is for activating the image processing apparatus 1000. For example, if the copy function of the image processing apparatus 1000 has been selected and the start key 230 is pressed, the image processing apparatus 1000 executes the copying operation. The power saving key 250 is for causing the image processing apparatus 1000 to shift to a low power consumption state. If the power saving key 250 is pressed, the image processing apparatus 1000 shuts down unnecessary power supply therein and shifts to the low power consumption state.

The human detection sensor 1080 is a sensor which obtains distribution information of a heat source (i.e., a human body). The human detection sensor 1080 converts the obtained distribution information of the heat source (i.e., the human body) to a digital signal and transmits the digital signal to a determination unit 1081 (illustrated in FIG. 4).

The operation unit 1090 includes a frame body which holds the display unit 200, the numeric keypad 210, the start key 230, the power saving key 250, and the human detection sensor 1080. The human detection sensor 1080 is arranged at the center of the lower side of the frame body. In other words, the human detection sensor 1090 is arranged at the position corresponding to a lower front side of the operation unit 1090 when the operation unit 1090 is used in the upright state.

FIGS. 3A, 3B, and 3C are enlarged views illustrating the arm 130 and the panel base 120.

More specifically, FIG. 3A illustrates an external view of the panel base 120 and the arm 130 when the image processing apparatus 1000 is viewed from the right side. FIG. 3B illustrates an external view of the panel base 120 and the arm 130 when the image processing apparatus 1000 is viewed from the back side. FIG. 3C illustrates an external view in which molds 910 and 920 configuring the arm 130 have been removed from the configuration illustrated in FIG. 3B.

Referring to FIGS. 3A, 3B, and 3C, the arm 130 includes the molds 910 and 920 and a support 900. Further, the arm 130 includes a first arm member 130a and a second arm member 130b connected to be rotatable in a vertical direction (i.e., in a direction of an arrow illustrated in FIG. 3A) with the hinge 140 as the fulcrum. Furthermore, the arm 130 is rotatable in horizontal direction (i.e., in the direction of the arrow illustrated in FIG. 3B) with a Y axis 901 as the fulcrum. The arm 130 may include three or more arm members and two or more hinges.

FIG. 4 is a block diagram illustrating an example of a configuration of the image processing apparatus 1000 including the controller 1030.

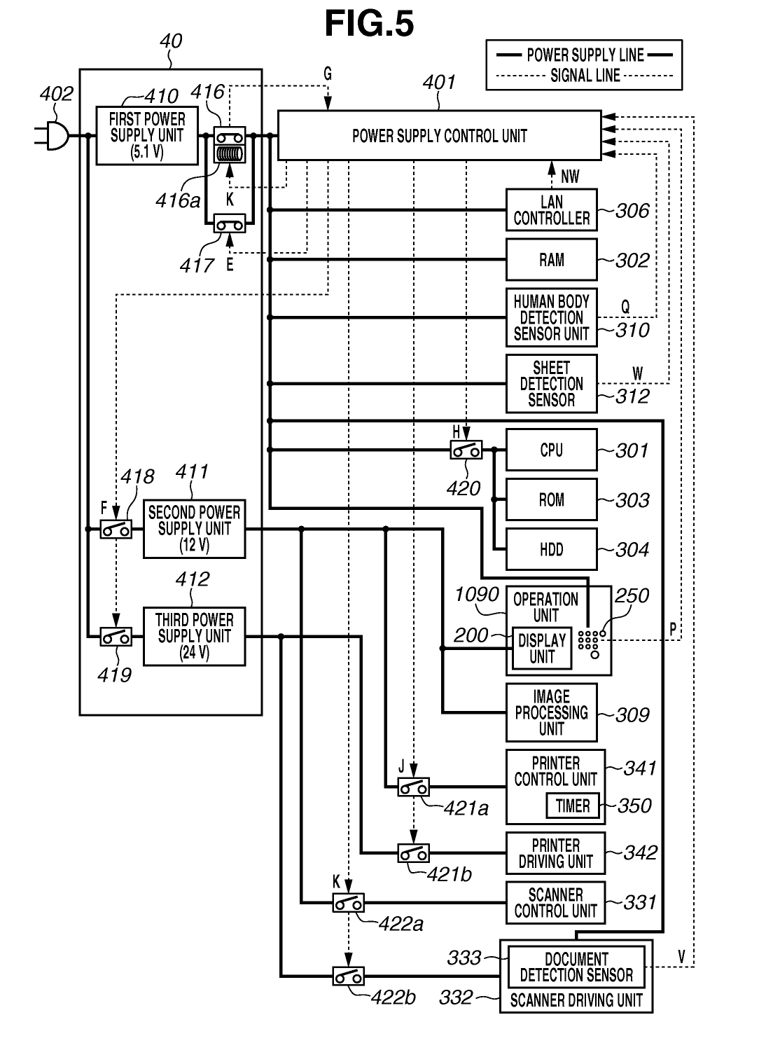

Referring to FIG. 4, according to the present exemplary embodiment, the image processing apparatus 1000 includes the controller 1030, the scanner unit 1100, the printer unit 1110, the operation unit 1090, and a power supply unit 40 to be described below with reference to FIG. 5.

Further, the image processing apparatus 1000 includes at least two power modes, i.e., a normal operation power mode (a normal operation power state) for performing a copying operation and the like, and a power saving mode (a power saving state) in which the power consumption is lower than the normal operation mode. If the image processing apparatus 1000 is not used even after a predetermined time has elapsed, the controller 1030 performs control so that the power mode of the apparatus shifts to the power saving mode. In the power saving mode, the power stops from being supplied to the scanner unit 1100 and the printer unit 1110, to a portion of the units in the controller 1030, and unnecessary portions in the operation unit 1090. Details will be described below.

### <Description of the Controller 1030>

The controller 1030 which controls the operations of the image processing apparatus 1000 will be described in detail below.

Referring to FIG. 4, the controller 1030 is electrically connected to the scanner unit 1100, the printer unit 1110, and the operation unit 1090 described above.

The controller 1030 includes a central processing unit (CPU) 301, a random access memory (RAM) 302, a read-only memory (ROM) 303, an operation unit interface (I/F) 305, a local area network (LAN) controller 306, a human body detection sensor unit 310, a sheet detection sensor 312, and a power supply control unit 401 which are connected to a system bus 307.

Further, the controller 1030 includes a hard disk drive (HDD) 304, an image processing unit 309, a scanner I/F 311, and a printer I/F 313 which are connected to an image bus 308.

The CPU 301 collectively controls access to each of connected devices based on control programs stored in the ROM 303 and various processes executed by the controller 1030. The RAM 302 is a system work memory for the CPU 301 to operate and a memory for temporarily storing image data. The RAM 302 includes a static RAM (SRAM) capable of maintaining stored contents even when the power is turned off and a dynamic RAM (DRAM) in which the stored contents are deleted when the power is turned off. The ROM 303 stores a boot program of the apparatus. The HDD 304 stores system software and the image data.

The operation unit I/F 305 is the interface for connecting the system bus 307 and the operation unit 1090. The operation unit I/F 305 receives image data to be displayed on the operation unit 1090 from the system bus 307 and outputs the received data to the operation unit 1090. Further, the operation unit I/F 305 outputs the information input from the operation unit 1090 to the system bus 307.

The LAN controller 306 controls input and output of information between the image processing apparatus 1000 and an external device 20 connected to a network 60.

The sheet detection sensor 312 detects whether a sheet has been set on the manual feed tray 110. The power supply control unit 401 controls the power supply to each unit in the image processing apparatus 1000. The power supply control unit 401 will be described in detail below. The image bus 308 is a transmission path for exchanging image data configured of a bus such as a peripheral components interconnect (PCI) bus or an Institute of Electrical and Electronic Engineers (IEEE) 1394.

The image processing unit 309 is used for performing image processing. The image processing unit 309 reads the image data stored in the RAM 302 and performs Joint Photographic Experts Group (JPEG) or Joint Bi-level Image Experts Group (JBIG) decompression or compression, and color adjustment.

### <Description of the Human Body Detection Sensor Unit 310>

The human body detection sensor unit 310 includes the human detection sensor 1080 and the determination unit 1081. A first power supply unit 410 (illustrated in FIG. 5) which is to be described below with respect to the power saving mode supplies the power to the human body detection sensor unit 310. The power is constantly supplied to the human detection sensor 1080. In contrast, the power supply to the determination unit 1081 may stop as appropriate. However, if the human detection sensor 1080 has detected a predetermined response, the power is immediately supplied to the determination unit 1081.

The human detection sensor 1080 is an infrared sensor array in which infrared sensors receiving infrared light are arranged in a matrix form. The human detection sensor 1080 receives the infrared light emitted from an object such as the person and thus detects that the person has approached the image processing apparatus 1000. According to the present exemplary embodiment, the human detection sensor 1080 detects the person. However, the human detection sensor 1080 is capable of detecting any object which emits the infrared light.

The human detection sensor 1080, i.e., an infrared array sensor, is a sensor, for example, in which a plurality of infrared light receiving elements (infrared sensors) is arranged in a M×N lattice shape. M and N are natural numbers and may be the same values. However, the arrangement of the plurality of infrared light receiving elements in the human detection sensor 1080 is not limited to the M×N lattice shape. Each of the infrared light receiving elements (infrared sensors) arranged in the lattice shape in the human detection sensor 1080, i.e., the infrared array sensor, receives the infrared light emitted from the heat source such as the human body. The human detection sensor 1080 then uses temperature values measured from infrared light amounts received by each of the infrared light receiving elements (i.e., light reception results). The human detection sensor 1080 thus identifies the shape of the heat source (i.e., a detection area) as temperature distribution. The image processing apparatus 1000 uses such a feature of the human detection sensor 1080 and detects the temperature of the heat source approaching the image processing apparatus 1000 and determines whether the heat source is a human body based on the shape and the temperature. When the temperature of one of the M×N infrared light receiving elements has exceeded a preset temperature, the human detection sensor 1080 is capable of outputting an interrupt signal. If the determination unit 1081 receiving the interrupt signal then reads out a register, the infrared light receiving element of which the temperature has exceeded the preset temperature can be determined. An interrupt function of the human detection sensor 1080 may be used for energizing or starting the operations of the determination unit 1081, or the determination unit 1081 may be constantly energized and read the detection result of the human detection sensor 1080 at fixed time intervals.

The determination unit 1081 processes the detection result of the human detection sensor 1080 to determine whether a user exists, and outputs an energizing request signal (i.e., a signal Q illustrated in FIG. 5) to the power supply control unit 401 according to the determination result. Upon receiving the signal Q, the power supply control unit 401 causes the power mode of the image processing apparatus 1000 to return to the normal operation power mode. The determination process performed by the determination unit 1081 will be described in detail below.

The scanner unit 1100 reads an image formed on a document and obtains the image data. The scanner unit 1100 inputs reflected light as a result of irradiating the image formed on the document with light to a charge-coupled device (CCD), and converts information of the image to an electric signal. The electric signal is converted to a luminance signal formed of each of red (R), green (G), and blue (B) colors, and is output to the controller 1030. The scanner unit 1100 includes a scanner control unit 331 and a scanner driving unit 332. The scanner driving unit 332 includes a sheet conveying motor for conveying the document set on the tray to a reading position of the scanner unit 1100 and physically drives the scanner unit 1100. The scanner control unit 331 controls an operation of the scanner driving unit 332. The scanner control unit 331 communicates with the CPU 301 and receives setting information specified by the user when performing scan processing. The scanner control unit 331 thus controls the operation of the scanner driving unit 332 based on the setting information.

The printer unit 1110 forms an image on the sheet using the input image data. The printer unit 1110 includes a printer control unit 341 and a printer driving unit 342. The printer driving unit 342 includes a motor for driving a photosensitive drum (not illustrated), a motor for rotating the fixing unit (not illustrated), and the sheet conveying motor, and thus physically drives the printer unit 1110. The printer control unit 341 controls an operation of the printer driving unit 342. The printer control unit 341 communicates with the CPU 301 and receives setting information specified by the user when performing print processing and thus controls the operation of the printer driving unit 342 based on the setting information. An image forming method of the printer unit 1110 is not limited to an electrophotographic method employing the photosensitive drum and a photosensitive member belt. For example, the printer unit 1110 may employ an inkjet method which discharges ink from minute nozzle arrays and prints on the sheet, or other printing methods.

### <Description of a Power Supply Circuit in the Image Processing Apparatus>

FIG. 5 illustrates an example of a power supply circuit in the image processing apparatus 1000. The power generated by the power supply unit 40 is supplied to each unit in the image processing apparatus 1000. The power supply unit 40 includes the first power supply unit 410, a second power supply unit 411, and a third power supply unit 412. A public power supply supplies alternative current power to the power supply unit 40 via a power plug 402.

The first power supply unit 410 converts the alternative current power supplied via the power plug 402 to direct current power (e.g., 5.1 V (i.e., first output power)). The direct current power is then supplied to the devices of a first power supply system (i.e., the power supply control unit 401, the CPU 301, the RAM 302, the ROM 303, the HDD 304, the LAN controller 306, the human body detection sensor unit 310, the sheet detection sensor 312, and buttons in the operation unit 1090). According to the present exemplary embodiment, the CPU 301 operates based on the power supplied from only the first power supply unit 410 without receiving the power supply from the second power supply unit 411 and the third power supply unit 412. In other words, the power supply of the CPU 301 is independent of the second power supply unit 411 and the third power supply unit 412.

The second power supply unit 411 converts the alternative current power supplied via the power plug 402 to the direct current power (e.g., 12 V (i.e., second output power)). The direct current power is then supplied to the devices of a second power supply system (i.e., the display unit 200 in the operation unit 1090, the image processing unit 309, the printer control unit 341 in the printer unit 1110, and the scanner control unit 331 in the scanner unit 1100).

The third power supply unit 412 converts the alternative current power supplied via the power plug 402 to the direct current power (e.g., 24 V). The direct current power is then supplied to the devices of a third power supply system (i.e., the printer driving unit 342 and the scanner driving unit 332).

A power switch 416 which becomes an on state or an off state by a user operation is disposed between the first power supply unit 410 and the devices of the first power supply system. The power switch 416 inputs a signal G indicating the state of the power switch 416 (i.e., the on state or the off state) to the power supply control unit 401. Further, a switch 417 formed of a field effect transistor (FED) arranged parallel to the power switch 416 is disposed between the first power supply unit 410 and the devices of the first power supply system. The switch 417 is changed from the on state to the off state or from the off state to the on state by a control signal E output from the power supply control unit 401. A voltage is applied to a solenoid 416a included in the power switch 416 according to a control signal K output from the power supply control unit 401 so that the power switch 416 becomes the off state.

When an automatic shutdown function and a remote shutdown function included in the image processing apparatus 1000 are executed, the power supply control unit 401 outputs the control signal K and drives the solenoid 416a. The power switch 416 is thus turned off. The automatic shutdown function shuts down the image processing apparatus 1000 when a predetermined time has elapsed without the user operation in a second sleep state to be described below. Further, the remote shutdown function shuts down the image processing apparatus 1000 according to a shutdown instruction transmitted from the external device 20.

A relay switch 418 is disposed between the power plug 402 and the second power supply unit 411. Further, a relay switch 419 is disposed between the power plug 402 and the third power supply unit 412. The relay switches 418 and 419 change from the on state to the off state or from the off state to the on state by a control signal F output from the power supply control unit 401.

A switch 420 is disposed between the power switch 416 and the CPU 301, the ROM 303, and the HDD 304. The switch 420 changes from the on state to the off state or from the off state to the on state by a control signal H output from the power supply control unit 401.

A switch 421a is disposed between the second power supply unit 411 and the printer control unit 341, and a switch 421b is disposed between the third power supply unit 412 and the printer driving unit 342. The switches 421a and 421b change from the on state to the off state or from the off state to the on state by a control signal J output from the power supply control unit 401. A battery (not illustrated) supplies the power to a timer 350 in the printer control unit 341 so that the timer 350 is capable of operating even when the power is not supplied to the printer control unit 341.

A switch 422a is disposed between the second power supply unit 411 and the scanner control unit 331, and a switch 422b is disposed between the third power supply unit 412 and the scanner driving unit 332. The switches 422a and 422b change from the on state to the off state or from the off state to the on state by a control signal K output from the power supply control unit 401.

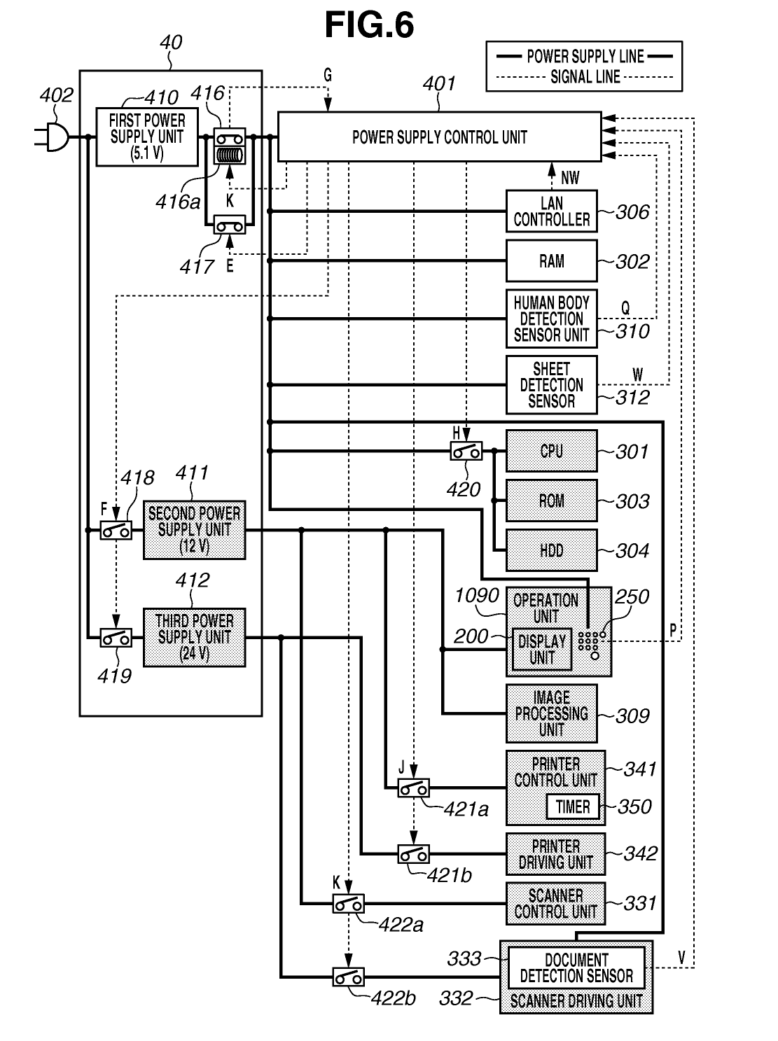

The power state of the image processing apparatus 1000 will be described below with reference to FIG. 6.

FIG. 6 illustrates the power state of the image processing apparatus 1000. Shaded portions illustrated in FIG. 6 indicate portions to which the power is not supplied.

### (1) Power Off State

The power off state is the state in which the power is not supplied to the units in the image processing apparatus 1000. In the power off state, each of the switches 416, 417, 418, 419, 420, 421a, 421b, 422a, and 422b are in the off state. The power off state may be a hibernation state.

### (2) Normal Operation Power Mode

In the normal operation power mode, the power is supplied to each of the units in the controller 1030, the operation unit 1090, the printer unit 1110, and the scanner unit 1100. More specifically, each of the switches 416, 417, 418, 419, 420, 421a, 421b, 422a, and 422b are in the on state in the normal operation power mode.

### (3) Power Saving Mode

In the power saving mode, the power is supplied to the power supply control unit 401, the RAM 302, the LAN controller 306, the human body detection sensor unit 310, the sheet detection sensor 312, the document detection sensor 333, and the buttons in the operation unit 1090. Further, the power is not supplied to the CPU 301, the ROM 303, the HDD 304, the image processing unit 309, the scanner unit 1100, and the printer unit 1110 in the power saving mode. This is as illustrated in FIG. 6. In other words, the power is supplied from the first power supply unit 410 to the devices of the first power supply system (i.e., the power supply control unit 401, the RAM 302, the LAN controller 306, the human body detection sensor unit 310, the sheet detection sensor 312, the document detection sensor 333, and the buttons) in the power saving mode. The switches 416 and 417 become the on state, and the other switches 418, 419, 420, 421a, 421b, 422a, and 422b become the off state. In the power saving mode, the user operations on the buttons in the operation unit 1090 can be received. Further, in the power saving mode, the LAN controller 306 is capable of receiving packets transmitted from the external device 20. Furthermore, in the power saving mode, the human body detection sensor unit 310 is capable of detecting that a person has approached the image processing apparatus 1000, the sheet detection sensor 312 is capable of detecting that a sheet has been set on the manual feed tray 110, and the document detection sensor 333 is capable of detecting that a document has been set on the manual feed tray 110.

The image processing apparatus 1000 may include other power modes.

For example, if the LAN controller 306 has received a packet (excluding a page description language (PDL) job) which the LAN controller 306 is not capable of independently responding to in the power saving mode, the image processing apparatus 1000 shifts from the power saving mode to a response mode (not illustrated). The response mode is the power state in which the switch 420 is changed to the on state from the state of the power saving mode, and the first power supply unit 410 supplies the power to the CPU 301, the ROM 303, and the HDD 304. In such a response mode, the CPU 301 uses the information stored in the HDD 304 and returns the response with respect to the packet received by the LAN controller 306 which the LAN controller 306 is not capable of independently responding to. After processing the packet, the image processing apparatus 1000 in the response mode then shifts to the power saving mode.

Further, if the timer 350 disposed in the printer control unit 341 has counted to a predetermined time in the power saving mode, the image processing apparatus 1000 shifts to an adjustment mode (not illustrated). The image processing apparatus 1000 shifts to the adjustment mode for preventing the photosensitive drum and a blade used for scraping off toner on the photosensitive drum from contacting each other at the same position for a long time. Upon shifting to the adjustment mode, the photosensitive drum rotates and relative positions between the photosensitive drum and the blade change. In the adjustment mode, the power is supplied to the printer control unit 341 and the printer driving unit 342 and not to the CPU 301 and the HDD 304. The switches 416, 417, 418, 419, 421a, and 421b are turned on and the switches 420, 422a and 422b are turned off in the adjustment state. After performing a specific operation (e.g., the rotation of the photosensitive drum) in the adjustment mode, the image processing apparatus 1000 re-shifts to the power saving mode.

The power supply control unit 401 will be described below.

The power supply control unit 401 is a complex programmable logic device (CPLD) and controls the image processing apparatus 1000 to shift to the above-described power states. The power is supplied to the power supply control unit 401 in the power saving mode, and the power supply control unit 401 detects a plurality of types of factors for returning from the power saving mode.

More specifically, the power supply control unit 401 receives a signal NW from the LAN controller 306 as the return factor. The LAN controller 306 outputs the signal NW to the power supply control unit 401 when the LAN controller 306 has received a PDL job.

Further, the power supply control unit 401 receives a signal P from the buttons in the operation unit 1090 as the return factor. The signal P is output to the power supply control unit 401 when the user operates on the buttons. Furthermore, the power supply control unit 401 receives a signal Q from the human body detection sensor unit 310 as the return factor. The human body detection sensor unit 310 outputs the signal Q to the power supply control unit 401 when the human body detection sensor unit 310 detects a person approaching image processing apparatus 1000.

Moreover, the power supply control unit 401 receives a signal V from the document detection sensor 333 as the return factor. The document detection sensor 333 outputs the signal V to the power supply control unit 401 when the document detection sensor 333 detects a document. Further, the power supply control unit 401 receives a signal W from the sheet detection sensor 312 as the return factor. When a sheet is set on the manual feed tray, the sheet detection sensor 312 outputs the signal W to the power supply control unit 401.

The power supply control unit 401 sets the states of the switches 417, 418, 419, 420, 421a, 421b, 422a, and 422b to the on state or the off state based on logic of the above-described return factors (i.e., the signals NW, P, Q, V, and W).

The power supply control unit 401, i.e., a signal output unit, outputs the control signals E, F, K, J, and H (i.e., sets a signal level to “High”), when the signal NW is input thereto. As a result, the image processing apparatus 1000 shifts to the normal operation power mode.

Further, the power supply control unit 401 similarly outputs the control signals E, F, K, J, and H (i.e., sets a signal level to “High”), when the signal P, Q, V, or W is input thereto as well. The image processing apparatus 1000 thus shifts to the normal operation power mode.

Furthermore, the signal G indicating the state of the power switch 416 is input to the power supply control unit 401. If the power switch 416 is set to the off state by a user operation, the signal G is input to the power supply control unit 401. The power supply control unit 401 then outputs the control signals E, F, K, J, and H (i.e., sets a signal level to “High”). The image processing apparatus 1000 thus shifts to the power off state.

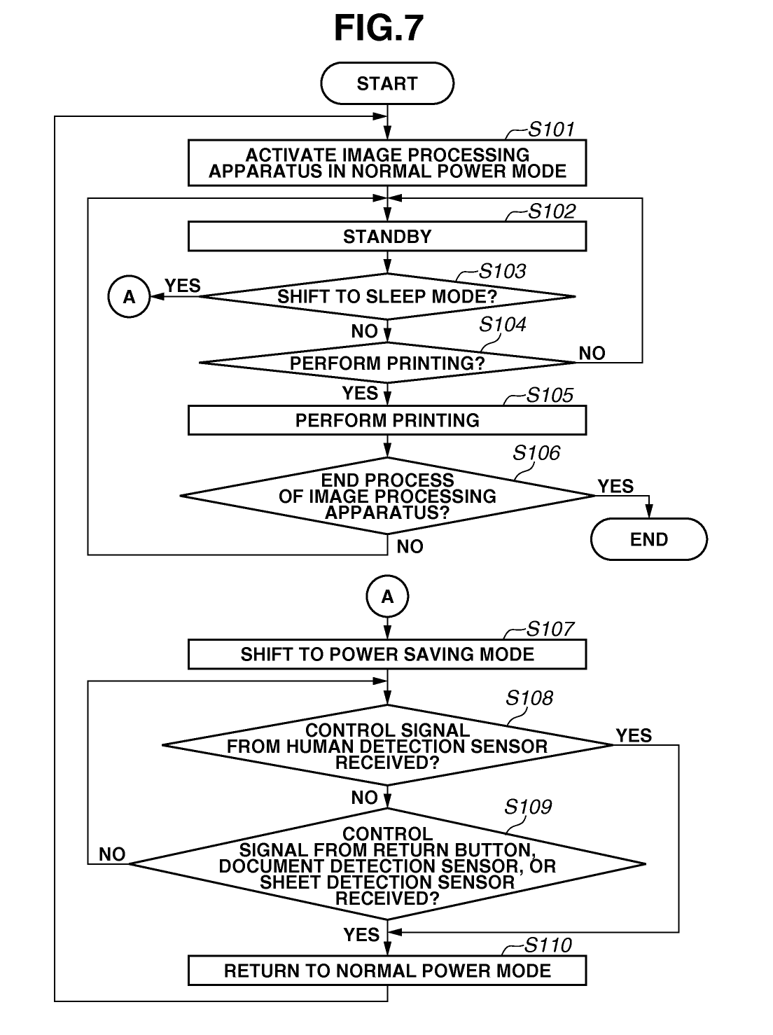

A process performed by the image processing apparatus 1000 will be described below with reference to FIG. 7.

FIG. 7 is a flowchart illustrating an example of the process performed by the image processing apparatus 1000. The processes of step S101 to step S107 illustrated in FIG. 7 are realized by the CPU 301 reading and executing the programs stored in the ROM 303. Further, the processes of step S108 to step S110 are realized by the power supply control unit 401 executing the program stored therein.

In step S101, after the image processing apparatus 1000 is switched on, the CPU 301 activates the image processing apparatus 1000 in the normal power mode. In step S102, the CPU 301 causes the image processing apparatus 1000 to stand by until an operator performs an operation. In step S103, the CPU 301 determines whether to shift to the power saving mode. In step S104, the CPU 301 determines whether to perform printing. If the CPU 301 determines not to shift to the power saving mode (NO in step S103) and not to perform printing (NO in step S104), the process returns to step S102 and CPU 301 continues to stands by.

If the CPU 301 determines not to shift to the power saving mode (NO in step S103) and then determines to perform printing (YES in step S104), the process proceeds to step S105. In step S105, the CPU 301 performs printing. In step S106, the CPU 301 determines whether to end the process of the image processing apparatus 1000. If the CPU 301 determines to end the process (YES in step S106), the CPU 301 turns off the power of the image processing apparatus 1000, and the process ends. On the other hand, if the CPU 301 determines not to end the process (NO in step S106), the process returns to step S102 and the CPU 301 returns the image processing apparatus 1000 to the standby state.

If the CPU 301 determines to shift to the power saving mode (YES in step S103), the process proceeds to step S107. In step S107, the CPU 301 performs a power saving mode shift process, and transmits a power saving mode shift instruction to the power supply control unit 401. Upon receiving the power saving mode shift instruction, the power supply control unit 401 outputs the control signals F, H, J, and K, and turns off the switches 418, 419, 420, 421a, 421b, 422a, and 422b.

After shifting to the power saving mode, the power supply control unit 401 monitors input of the control signals (Q, P, V, or W) from the human detection sensor 1080, a return button, the document detection sensor 333, or the sheet detection sensor 312. In step S108, the power supply control unit 401 determines whether there is detection by the human detection sensor 1080, and in step S109, the power supply control unit 401 determines whether there is detection by the return button, the document detection sensor 333, or the sheet detection sensor 312. If there is input of the control signal (Q, P, V, or W) (YES in step S108 or step S109), the process proceeds to step S110. In step S110, the power supply control unit 401 causes the image processing apparatus 1000 to return to the normal power mode. The process then returns to step S101. More specifically, the power supply control unit 401 outputs the control signals F, H, J, and K, and turns on the switches 418, 419, 420, 421a, 421b, 422a, and 422b. The power is then supplied to each of the units including the CPU 301, and the image processing apparatus 1000 is activated in the normal power mode. In step S102, the CPU 301 returns the image processing apparatus 1000 to the above-described standby mode.

An attachment angle and an attachment position of the human detection sensor 1080 will be described below.

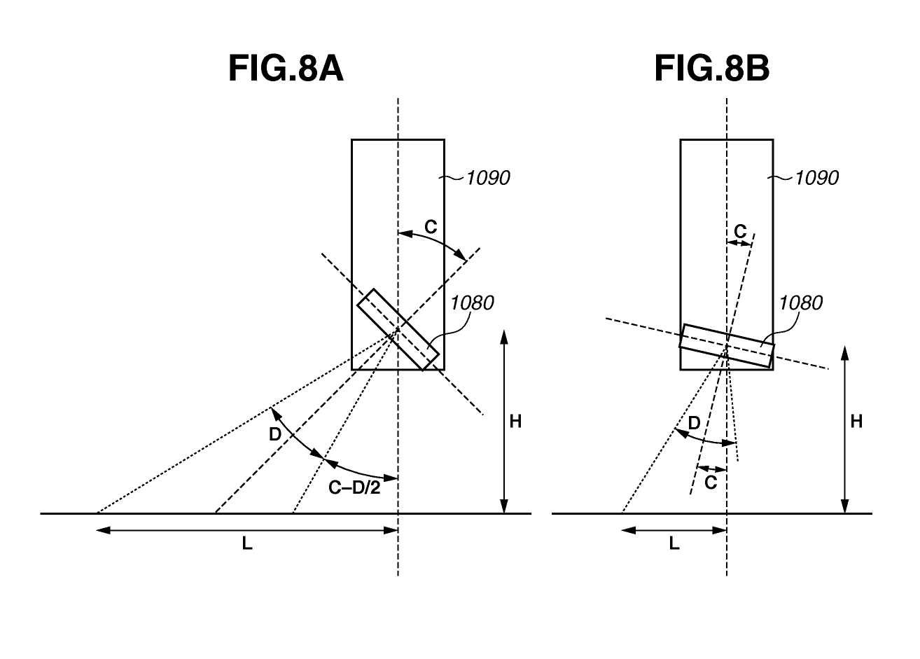

FIGS. 8A and 8B illustrate a determination method of an attachment angle C in the case where the human detection sensor 1080 is attached to the operation unit 1090.

According to the present exemplary embodiment, the attachment angle C is defined as 0 degrees when the human detection sensor 1080 is attached so that a detection surface thereof is directed downwards, and as 90 degrees when the human detection sensor 1080 is attached so that the detection surface thereof is directed horizontally.

More specifically, FIG. 8A illustrates an attachment state in the case where the attachment angle C is greater than half of a viewing angle D of the human detection sensor 1080. FIG. 8B illustrates the attachment state in the case where the attachment angle C is less than half of the viewing angle D of the human detection sensor 1080.

Referring to FIGS. 8A and 8B, the height to the human detection sensor 1080 is indicated as H, and a detection distance of the heat source (i.e., the human body) of the human detection sensor 1080 is indicated as L. The relation between the attachment angle C, the viewing angle D of the human detections sensor 1080, the height H, and the detection distance L can then be expressed as equation (1).

tan(D/2+C)=L/H (1)

Equation (1) is common to both FIGS. 8A and 8B.

The attachment angle C can be determined from equation (1) using equation (2).

C=arctan(L/H)−D/2 (2)

The human detection sensor 1080 will be additionally described below.

According to the present exemplary embodiment, the human detection sensor 1080 obtains distribution information of the heat source (i.e., the human body) without using a light emitting source. Further, the human detection sensor 1080 does not include a function for obtaining brightness around the sensor.

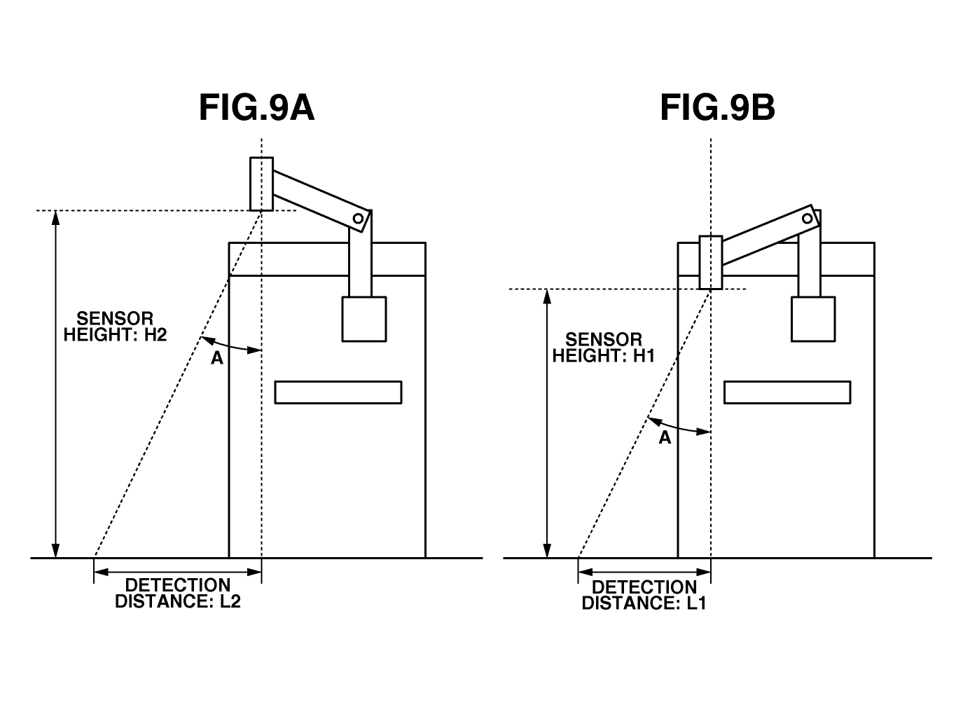

FIGS. 9A and 9B illustrate examples of the relation between the height of the operation unit 1090 in the image processing apparatus 1000 and the detection distance.

More specifically, FIG. 9A illustrates the case where the operation unit 1090 is at the highest position, and FIG. 9B illustrates the case where the operation unit 1090 is at the lowest position.

According to the present exemplary embodiment, the angle of the human detection sensor 1080 on the operation unit 1090 is fixed. In the case illustrated in FIG. 9A, the relation between a detection distance L2 of the human detection sensor 1080, a height H2 of the infrared array sensor, and a detection angle A of the human detection sensor 1080 is indicated by equation (3).

tan(A)=L2/H2 (3)

In the case illustrated in FIG. 9B, the relation between a detection distance L1 of the human detection sensor 1080, a height H1 of the infrared array sensor, and the detection angle A of the human detection sensor 1080 is indicated by equation (4).

tan(A)=L1/H1 (4)

As indicated by equations (3) and (4), the detection distance (L2 and L1) changes according to the position of the operation unit 1090 (H2 and H1). The detection angle A of the human detection sensor 1080 is the same as C+D/2 illustrated in FIG. 8A.

There may be a mechanism for maintaining orientation of the human detection sensor 1080 by changing the angle of the human detection sensor 1080 according to the change in the angle of the operation unit 1090.

As described above, the infrared array sensor is arranged on the lower front side of the operation unit directed downwards. In other words, the infrared array sensor is arranged so that a detection direction (i.e., the detection surface of the infrared array sensor) is in an obliquely downward direction at the position in the direction of the operation unit as viewed from the image processing apparatus. The infrared array sensor is arranged in such a direction even if the position of the operation unit with respect to the image processing apparatus is changed. As a result, movement of the heat source (i.e., the human body) approaching the image processing apparatus to operate the apparatus can be correctly detected, and malfunction can be reduced by performing device control using the sensor. Wasteful consumption of power due to the malfunction can thus be reduced.

According to the above-described first exemplary embodiment, the human detection sensor 1080 is arranged on the operation unit 1090. According to a second exemplary embodiment, the case where the human detection sensor 1080 is arranged on the arm 130 of the image processing apparatus 1000 will be described below.

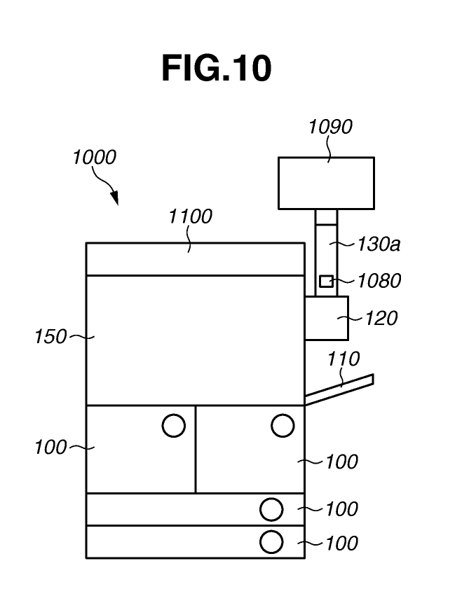

FIG. 10 illustrates the human detection sensor 1080 arranged on the arm 130. The components which are similar to those illustrated in FIG. 1 are assigned the same reference numerals.

Referring to FIG. 10, the human detection sensor 1080 is arranged at the position facing the front with the operation unit 1090 at the position facing the front. The human detection sensor 1080 is arranged on the front side of the first arm member 130a so that the detection surface (i.e., the detection direction) of the human detection sensor 1080 is always in the direction of the operation unit 1090 as viewed from the image processing apparatus 1000 in the horizontal direction. The determination method of the attachment angle C of the human detection sensor 1080 is similar to the method described with reference to FIGS. 8A and 8B.

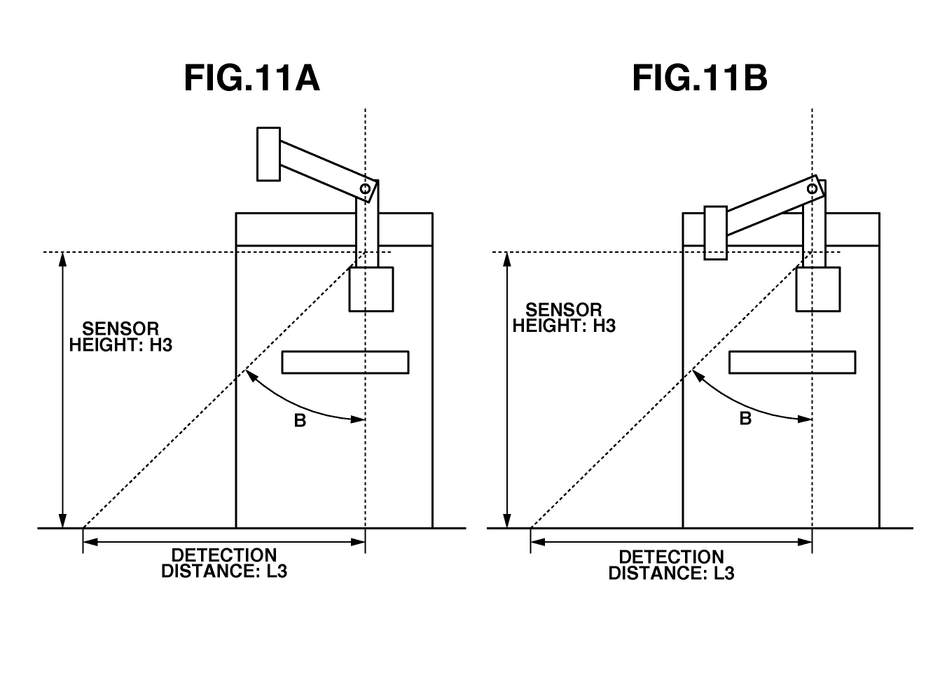

The first arm member 130a rotates along with the operation unit 1090 in the horizontal direction. However, the angle of the first arm member 130a does not change in the vertical direction even if the position or the angle of the operation unit 1090 changes in the vertical direction. As a result, the position or the detection direction of the human detection sensor 1080 does not change in the vertical direction even when the position or the angle of the operation unit 1090 changes in the vertical direction. In other words, the position or the orientation (the detection direction) of the human detection sensor 1080 is fixed in the vertical direction. The details will be described below with reference to FIGS. 11A and 11B.

FIGS. 11A and 11B illustrate that, when the human detection sensor 1080 is arranged on the arm 130, the detection distance does not change even when the height of the operation unit 1090 changes.

More specifically, FIG. 11A illustrates the case where the operation unit 1090 is at the highest position, and FIG. 11B illustrates the case where the operation unit 1090 is at the lowest position.

Referring to FIGS. 11A and 11B, the vertical position or the angle in the vertical direction of the human detection sensor 1080 does not change even when the angles of the first arm member 130a and the second arm member 130b are changed so that the position of the operation unit 1090 is changed in the vertical direction. Further, the vertical position or the angle in the vertical direction of the human detection sensor 1080 does not change even when the arm 130 is rotated around the Y axis. The detection distance L can thus be fixed regardless of the position of the operation unit 1090 with respect to the image processing apparatus 1000.

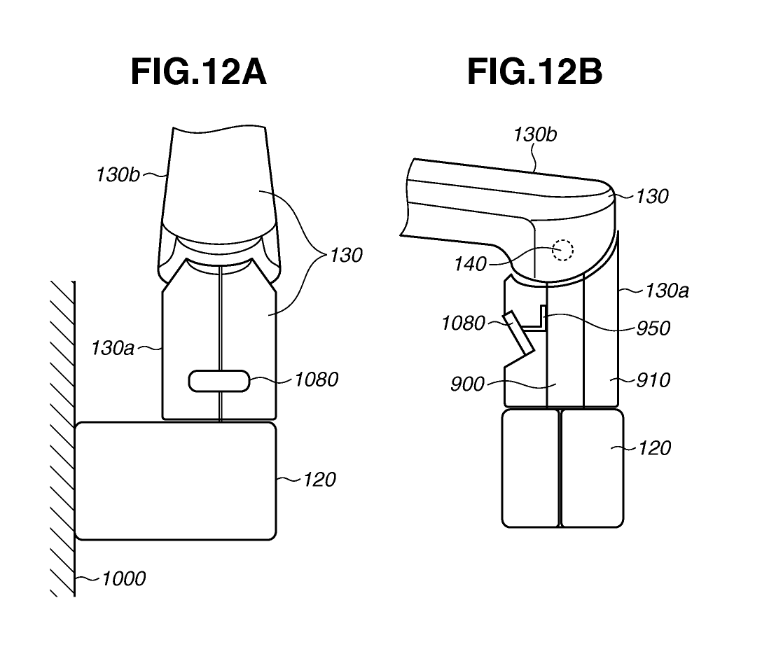

FIGS. 12A and 12B illustrate examples of arrangement of the human detection sensor 1080.

More specifically, FIG. 12A illustrates an external view of the panel base 120 and the arm 130 when the image processing apparatus 1000 is viewed from the front. FIG. 12B illustrates an external view of the panel base 120 and the arm 130 when the image processing apparatus 1000 in which the mold 920 has been removed is viewed from the right side.

Referring to FIGS. 12A and 12B, the molds 910 and 920 include openings for exposing the human detection sensor 1080. The human detection sensor 1080 is attached to a sensor supporting unit 950. The sensor supporting unit 950 is fixed to the support 900 of the arm 130. The sensor supporting unit 950 may be fixed to the support 900 by any method such as welding and screwing.

According to the present exemplary embodiment, the human detection sensor 1080 is fixed to the arm 130 using the sensor supporting unit 950. The human detection sensor 1080 may be fixed by disposing a member for fixing the human detection sensor 1080 to the molds 910 and 920 and be fixed using the molds 910 and 920.

As described above, the infrared array sensor is arranged on the front side of the arm supporting the operation unit (i.e., on the side corresponding to the direction of the operation surface of the operation unit), directed downwards. In other words, the infrared array sensor is arranged so that the detection direction (i.e., the detection surface of the infrared array sensor) is in the obliquely downward direction at the position in the direction of the operation unit as viewed from the image processing apparatus. The infrared array sensor is arranged in such a direction even if the position of the operation unit is changed with respect to the image processing apparatus. As a result, the movement of the heat source (i.e., the human body) approaching to operate the image processing apparatus can be correctly detected, and the malfunction can be reduced by performing device control using the sensor. The wasteful consumption of power due to the malfunction can thus be reduced.

According to the above-described exemplary embodiments, the human detection sensor 1080 is arranged so that the detection direction thereof is directed in a forward and obliquely downward direction. However, it is not limited thereto. The human detection sensor may be arranged at other positions and angles as long as the person approaching the image processing apparatus 1000 is correctly detectable.

Further, according to the above-described exemplary embodiments, the human detection sensor 1080 is the infrared array sensor. However, it is not limited thereto. Any sensor other than the infrared array sensor may be used as long as the sensor is capable of detecting that the object has approached the image processing apparatus 1000. Furthermore, additional embodiments may be applied to apparatuses (i.e., electronic devices) other than the image processing apparatus so that the person approaching an apparatus to operate the apparatus is detected and the apparatus is controlled.

The configuration and the contents of the above-described types of data are not limited thereto, and may be of various configurations and contents according to a usage and the objective.

The above-described exemplary embodiments may be in the form of a system, an apparatus, a method, a program, or a storage medium. More specifically, exemplar embodiments may be applied to a system configured of a plurality of devices or to an apparatus configured of a single device.

Further, combinations of the above-described exemplary embodiments are also applicable.

The above-described exemplary embodiments may be realized by providing software (a program code) for implementing the functions of these exemplary embodiments to the system or the apparatus via the network or various types of storing media, and a computer (i.e., the CPU or a micro-processing unit (MPU)) reading and executing the program code.

Further, the present disclosure may be applied to the system configured of the plurality of devices or to the apparatus configured of the single device.

The above-described exemplary embodiments, and various modifications (including organic combinations of the exemplary embodiments) may be made without departing from the spirit and the scope of the present disclosure. In other words, the combinations of the above-described exemplary embodiments and the modifications constitute the present disclosure.

According to the above-described exemplary embodiments, the person approaching the apparatus to operate the apparatus can be correctly detected, so that the malfunction in controlling the apparatus is reduced, and the wasteful power consumption due to the malfunction is reduced.

Additional embodiments can also be realized by a computer of a system or apparatus that reads out and executes computer executable instructions recorded on a storage medium (e.g., computer-readable storage medium) to perform the functions of one or more of the above-described embodiment(s), and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that these exemplary embodiments are not seen to be limiting. The scope of the following claims is to be accorded the broadest interpretation so as to encompass all such modifications and equivalent structures and functions.

This application claims the benefit of Japanese Patent Application No. 2014-040490 filed Mar. 3, 2014, which is hereby incorporated by reference herein in its entirety.

What is claimed is:

1. An information processing apparatus comprising:
an operation unit configured to receive an input from a user operating the information processing apparatus;
an arm member configured to connect a main body of the information processing apparatus and the operation unit; and
a detection unit, attached to the arm member or the operation unit attached to the arm member, configured to detect the user operating the information processing apparatus.

2. The information processing apparatus according to claim 1, wherein the detection unit is disposed at a lower side of the operation unit.

3. The information processing apparatus according to claim 1, wherein the detection unit is arranged so that a detection area of the detection unit is facing an installation surface of the information processing apparatus.

4. The information processing apparatus according to claim 1, wherein the arm member allows a position of the operation unit to change with respect to the main body of the information processing apparatus.

5. The information processing apparatus according to claim 1, wherein the detection unit detects temperature of an object.

6. The information processing apparatus according to claim 1, wherein the detection unit includes an infrared light receiving element which receives infrared light emitted from an object.

7. The information processing apparatus according to claim 6, wherein the detection unit is a sensor in which a plurality of the infrared light receiving elements is linearly arranged or arranged in a lattice shape.

8. The information processing apparatus according to claim 1, further comprising a printing unit configured to print an image on a sheet.
